(19) United States
(12) Patent Application Publication
(10) Pub. No.: US 2015/0144339 A1
(43) Pub. Date: May 28, 2015

(54) CONTROLLED INHOMOGENEOUS PROPPANT AGGREGATE FORMATION

(71) Applicant: SCHLUMBERGER TECHNOLOGY CORPORATION, Sugar Land, TX (US)

(72) Inventors: Sergey Semenov Vladimirovich, Kurgan (RU); Mohan K.R. Panga, Katy, TX (US); Geza Horvath Szabo, Sugar Land, TX (US); Maxim Pavlovich Yutkin, Berdsk (RU); Ksenia Mikhailovna Kaprielova, Novosibirsk (RU); Nikolay Borisovich Gorshkov, Novosibirsk (RU)

(21) Appl. No.: 14/553,208

(22) Filed: Nov. 25, 2014

(30) Foreign Application Priority Data
Nov. 25, 2013 (RU) PCT/RU2013/001054

(51) Int. Cl. C09K 8/80; E21B 43/267

(52) U.S. Cl. CPC C09K 8/80; E21B 43/267
USPC 166/280.2

(57) ABSTRACT

A method to improve fluid flow in a hydraulic fracture from a subterranean formation which includes the steps of (1) formulating a slurry which comprises (a) proppant particles, (b) a carrier fluid, and (c) low density particles, wherein the fluid is capable of undergoing a transformation to cause an agglomeration of two or more proppant particles and/or low density particles; and (2) injecting the slurry into the formation; and (3) the agglomeration of the proppant particles and/or low density particles, is provided.

### RELATED APPLICATIONS

The present application claims priority to International Application No. PCT/RU2013/001054, filed, Nov. 25, 2013, the entirety of which is incorporated by reference herein.

### BACKGROUND

Fracturing is used to increase permeability of subterranean formations. A fracturing fluid is injected into the wellbore passing through the subterranean formation. A propping agent (proppant) is injected into the fracture to prevent fracture closing and, thereby, to provide improved extraction of extractive fluids, that is oil, gas or water.

The proppant maintains the distance between the fracture walls in order to create conductive channels in the formation. Heterogeneous proppant placement (HPP) further increases formation conductivity and enhances fluid production.

Tight formations such as shales or tight sands may be treated with low viscosity fluids such as slickwater. In low viscosity fracturing fluid treatments the proppant tends to settle thereby decreasing fluid production. Further, placement of proppant in deep fractures and high vertical coverage within the formation is still challenging in tight formations.

### SUMMARY

In at least one aspect, the disclosure provides a method to improve fluid flow in a hydraulic fracture which includes the steps of (1) formulating a slurry which includes (a) proppant particles, (b) a carrier fluid, and (c) low density particles, wherein the fluid is capable of undergoing a transformation to cause the coagulation or aggregation or accumulation or agglomeration of two or more proppant particles and/or low density particles; and (2) injecting the slurry into a formation; and (3) triggering an agglomeration of proppant particles and/or low density particles. Triggering may occur before, during or after injecting the slurry into the formation.

In another aspect, the disclosure provides a method of inducing proppant aggregation or accumulation in a hydraulic fracture which includes the steps of (1) formulating a proppant carrier fluid comprising (i) at least one anionic polyelectrolyte or a precursor to at least one anionic polyelectrolyte, and (ii) at least one cationic polyelectrolyte or the precursor to at least one cationic polyelectrolyte; (2) injecting a slurry of the proppant carrier fluid, proppant, and low density particles; and (3) triggering formation of a polyelectrolyte complex.

In yet another aspect, the disclosure provides a method to improve fluid flow in a hydraulic fracture. The method includes (1) formulating a slurry which comprises (a) proppant particles, (b) a carrier fluid, (c) low density particles, wherein the fluid is capable of undergoing a transformation to cause the agglomeration of two or more proppant particles and/or low density particles, (d) a first component of a polyelectrolyte complex, and a (e) a second component of the polyelectrolyte complex held within containers made from degradable material at appropriate well downhole conditions and/or any type of containers which are subjected to pressure/shear degradation; (2) injecting the slurry into a formation; and (3) triggering coagulation or aggregation or accumulation or agglomeration of two or more proppant particles and/or low density particles. The triggering may occur before, during or after injecting the slurry into the formation.

This summary is provided to introduce a selection of concepts that are further described below in the detailed description. This summary is not intended to identify key or essential features of the claimed subject matter, nor is it intended to be used as an aid in limiting the scope of the claimed subject matter.

### DETAILED DESCRIPTION OF SOME ILLUSTRATIVE EMBODIMENTS

For the purposes of promoting an understanding of the principles of the disclosure, reference will now be made to some illustrative embodiments of the current application.

Although the following discussion emphasizes fracturing, the polymer gel phase transitions and polymer gel chemical transformations of the disclosed subject matter may be used in fracturing, gravel packing, and combined fracturing and gravel packing in a single operation. Some embodiments of the disclosed subject matter may be described in terms of treatment of vertical wells, but are equally applicable to wells of any orientation. Embodiments may be described for hydrocarbon production wells, but it is to be understood that embodiments may be used for wells for production of other fluids, such as water or carbon dioxide, or, for example, for injection or storage wells. It should also be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. It should also be understood that fracture closure includes partial fracture closure.

As used herein, the term hydraulic fracturing treatment means the process of pumping fluid into a closed wellbore to create enough downhole pressure to crack or fracture the formation. This allows injection of proppant-laden fluid into the formation, thereby creating a region of high-permeability sand through which fluids can flow. The proppant remains in place once the hydraulic pressure is removed and therefore props open the fracture and enhances flow into or from the wellbore.

In the disclosed subject matter, any one or more processes to create the coagulation or aggregation or accumulation of two or more particles may be used; these processes are referred to collectively as syneresis of an additive or more than one additive dissolved or distributed in the fluid. Syneresis is defined herein as water expulsion from a gel (or solution of a polymer in water or water/organic solvent/supercritical solvent mixture). Syneresis can lead to phase separation, precipitation, phase transition, or collapse of gel. For example, overcrosslinking of guar gel is syneresis; precipitation of oily substance resulted from interaction of two oppositely charged long chain polymers is syneresis; precipitation of a polymer from solution due lowering its solubility at elevated temperature is syneresis.

Macroscopically, syneresis, precipitation, and phase separation can be described as the properties of the fluid; hence, reference is made herein to strictly the syneresis of the fluid. In the context of the disclosed subject matter herein, the coagulation or aggregation or accumulation expressions cover different physical/chemical mechanisms, which alter the originally statistically homogeneous distribution of the proppant particles in the fracturing fluid and make their concentration inhomogeneous in space beyond the statistical oscillation. In one embodiment, the coagulation or aggregation or accumulation of two or more particles results in heterogeneous proppant placement. As used herein, coagulation or aggregation or accumulation of two or more particles includes one or more of coagulation or aggregation or accumulation of two or more proppant particles or coagulation or aggregation or accumulation of at least one proppant particle with at least one low density particle. The coagulation or aggregation or accumulation or agglomeration of two or more particles may result in inhomogeneity on the micron or greater scale. The terms “slug(s)”, “island(s)” or “pillar(s)” assume any particle accumulation containing more than one grain of sand and/or proppant.

Coagulation or aggregation or accumulation or agglomeration of two or more particles, for example placement of proppant in a fracture as consolidated clusters (for example pillars) thus creating open channels in the fracture, can improve fracture conductivity above the limits of conventional proppant packs. In contrast to an approach in which proppant placement mainly relies on a special pumping schedule, the disclosed subject matter encompasses methods in which proppant cluster, i.e. agglomerate or aggregate, formation timing and location are controlled by physical or chemical means through polymer gel phase transitions or chemical transformations.

In a particular embodiment, low density particles have a specific gravity (in relation to that of water) of equal to less than 1. All individual values and subranges of equal to or less than 1 are included herein and disclosed herein. For example, the specific gravity of the low density particles may be equal to or less than 1, or equal to or less than 0.9, or equal to or less than 0.8.

The coagulation or aggregation or accumulation or agglomeration of two or more particles according to the disclosed subject matter may occur in situ in a particular embodiment. The methods of in situ cluster formation used in one embodiment of the disclosed subject matter utilize low density particles. As used herein, the term “low density particles” means particles having a specific gravity less than the specific gravity of the proppant being used. Thus, the term “low density particles” does not refer to any particles having a stated specific gravity but rather to particles which have a lower specific gravity in comparison to that of the proppant used in a particular application.

In alternative embodiments of the disclosed subject matter the agglomeration of two or more particles may occur prior to injection into the well. Alternatively, the agglomeration may occur during injection into the well or in the fracture.

Low density particles include hollow spheres, ash, wood, plastic, superabsorbents, and guar based materials (e.g. gel or powder, crosslinked or uncrosslinked). Moreover, hydrocarbon dispersions and gas dispersions having a specific gravity less than that of the proppant may be used as “low density particles” herein. Moreover, foamed materials/minerals, such as, pumice, vermiculite, perlite, plastic foam, may be used as low density particles in embodiments of the disclosed subject matter. In addition, synthetic or natural solid foams of either organic or inorganic formulation may be used.

In one embodiment of the disclosed subject matter a polymer gel used as the viscosifier of a fracturing fluid is deliberately subjected to syneresis.

Prior to the disclosed subject matter, such process was considered undesirable, as such an exposure may affect the rheological properties of the fracturing fluid, and special efforts were often undertaken to avoid or diminish it. However, if properly controlled, syneresis can lead to proppant particle aggregation or accumulation. The resulting polymer clots entrap and retain proppant or proppant plus low density particles inside them thereby controlling the density of the aggregate resulting from the coagulation or aggregation or accumulation or agglomeration; the distance between proppant particulates in the clots is smaller than in the original homogeneous slurry. The proppant or proppant plus low density particles aggregates (clusters) keeping the fracture from closure provide channels in between them and, thus, enhanced fracture conductivity. Irrespective of the manner in which syneresis occurs, the coagulation, aggregation, accumulation or agglomeration of the proppant and/or lightweight particles is referred to herein as agglomeration. Similarly, whether two or more proppant particles and/or lightweight particles come together by coagulation, aggregation, accumulation or agglomeration, the process is referred to herein as “agglomeration” and the cluster of particles referred to interchangeably as an aggregate or agglomerate. In the disclosed subject matter, syneresis and/or agglomeration may occur before, during or after injection of the slurry into the formation.

In the disclosed subject matter the syneresis can be controlled by various means.

In one embodiment, the syneresis is caused by including in the fluid, in addition to the polymer in the first polymer gel, a second polymer and a delayed crosslinker for the second polymer. The second polymer is optionally at a concentration below its overlap concentration.

In one embodiment of the disclosed subject matter, syneresis is used to cause the coagulation or aggregation or accumulation or agglomeration of two or more particles. One method of causing and controlling syneresis is the use of borate-crosslinked polymer gels and multivalent cations. It is believed that this works with Ti and Zr-crosslinked gels as well. For example, the addition of calcium hydroxide to a borate-crosslinked gel causes syneresis. For example, calcium chloride, borate, and polymer are mixed at the surface. A hydroxide, or a delayed source of hydroxide such as magnesium oxide to generate the calcium hydroxide in situ, is added. Syneresis occurs after sufficient multivalent cation hydroxide is present. The more calcium ion present, the greater and faster the syneresis. Other multivalent cations may be used, for example Zn, Al, Mg, Fe, Cu, Cr, Co, Ti, Zr, and/or Ni. The level of syneresis may not depend on the multivalent ion concentration but also on the borate crosslinking density. For example, excess of borate cross-linker alone can be added to guar gel to cause syneresis with the absence of multivalent cations.

It should be noted that an inexpensive and/or unmodified guar may be used because the function may not be to provide viscosity and because impurities are not a problem if they become part of the agglomerated proppant or proppant plus low density particles. While syneresis is herein described as being caused and controlled by use of borate-crosslinked polymer gels and multivalent cations, it will be understood that any method of causing and controlling syneresis may be used in various embodiments of the disclosed subject matter.

The interaction of polyelectrolytes of opposite charge in solution results in aggregation and formation of a polyelectrolyte complex (PEC). In another non-limiting embodiment polyelectrolyte complexes (PECs) can be formed in the following way. One of the PECs components can be included into degradable highly viscous phase (e.g. cross-linked guar, cross-linked CMC, etc.—it can be together or separate with proppant in this phase), any type of degradable phase which is not miscible with carrier fluid, any type of containers consisting from degradable/material at well downhole conditions (e.g. polyvinyl alcohol, polylactic acid, etc.), or any type of containers which are subjected to pressure/shear degradation. As used in connection with containers herein, the term degradable refers to materials whose chemical structure breaks down or changes as well as materials which are soluble at well downhole conditions. As used herein, downhole conditions includes temperatures above about 50° C. The other PECs additives known in the art are pumped together with the counter part of the masked component (by means of one or two streams). While in the fracture the highly viscous phase or containers break by the influence of high temperature, pressure, shear, or breaker and release the polyelectrolyte, which reacts with the surrounding counterpart resulting in aggregation of sand in tight flocks. The degree of agglomeration in the newly formed PEC is higher than in the gel.

In another embodiment of the disclosed subject matter the polymer clots are formed due to interactions between two different polymers, triggered chemically or by use of physical stimuli, such as temperature and/or pressure. An example is the formation of complexes between two oppositely charged polyelectrolytes. The interaction of polyelectrolytes of opposite charge in solution results in syneresis and formation of a polyelectrolyte complex (PEC); complex formation is accompanied by aggregation or accumulation of proppant or proppant plus low density particles.

Many PEC structures are known. One is based on the formation of nearly stoichiometric complexes between polyelectrolytes of similar molecular weights; this is called a “ladder”-type complex, in which oppositely charged polymeric chains are aligned and linked ionically. Water-soluble, ordered, non-stoichiometric complexes with the ladder-type structure are also known. In more disordered PECs, the structure of which has been referred to as “scrambled egg”-type, the polymer chains coil, forming a structure with statistical charge compensation. Such complexes often have highly non-stoichiometric ratios of polyelectrolytes and are characterized by very low solubility. In one embodiment of the disclosed subject matter, such complexes are used.

Formation of PECs with a scrambled egg type structure allows entrapment of proppant or proppant plus low density particles in the clots. It should be mentioned that the aggregation or accumulation forces holding the particles in clusters are much stronger than in the case of flocculation. Particles subjected to flocculation have sizes generally not exceeding about 150 microns (100 US mesh). Organic flocculants, which may include water-soluble polymers, provide molecular interlinks between the particles, so the resulting flocs are held by coiled, yet linear, polymer chains. In contrast, PEC clots represent highly crosslinked 3D networks of polymer chains, which may, additionally, as in the case of flocculants, have an affinity to the surfaces of entrapped particles due to electrostatic, van der Waals, hydrogen bonding and other forces.

The resulting average density (specific gravity) of PEC agglomerates can be controlled by addition of low density additive like hollow spheres, ash, wood, pumice, guar, gas. Since PECs have high affinity to surfaces they will entrap sand and lightweight additives.

In one example lightweight additives can be added in dry form as in case of hollow glass spheres. In another example they can be added in liquid form as in case of guar gel. In yet another example the additive can be added in gas form. In one more example a mixture of chemicals can be designed in such a way that it releases gas upon bottomhole conditions. Releasing gas bubbles can be further entrapped and consolidated by forming PEC. This would result in lower density of the agglomerate.

The formation of PECs can be controlled in a variety of ways. pH delaying agents, known to those skilled in art, can be used to adjust the pH of a fracturing fluid and initiate PEC formation in a fracture. PEC formation and details may be found in PCT/RU2010/000207, the disclosure of which is incorporated herein by reference in its entirety. In a non-limiting example, the fracturing slurry, in addition to proppant, low density particles and other additives, is made from two polyacrylamide copolymers, the first of which is made with acrylic acid as one monomer and the second of which is made with DADMAC as one monomer. When the slurry pH is kept below about 4.0, most of carboxylic groups of PAM-PA (polymer of acrylamide and acrylic acid) exist in a non-dissociated (protonated) form and the PAM-PA polymer does not exhibit any polyelectrolyte properties. Once the slurry pH is raised above about 5.0, carboxylic acid groups start dissociating and the resulting PAM-PA polyelectrolyte undergoes complexation with the PAM-DADMAC, forming low soluble PEC clots with entrapped proppant or proppant plus low density particles.

Another method of controlling PEC formation is in situ synthesis of one polyelectrolyte downhole. In a non-limiting example, the Mannich aminomethylation or Hofmann degradation reactions of polyacrylamide polymer are used to produce polycationic species from initially neutral PAM. Both reactions proceed in aqueous solutions at temperatures above about 50° C. In the Mannich reaction, a PAM is treated with formaldehyde and an amine which results in formation of Mannich base groups (—NH—CH₂—NR₂), which are positively charged even in solutions with relatively high pH values; the product is a polycation. Secondary amines, for example diethyl and dipropylamine, as well as ammonia and primary amines may be used. Formaldehyde can be obtained downhole from a precursor (for example urotropin (hexamethylenetetramine)), so no toxic substances are needed at a well site. Another method of generating a polyelectrolyte downhole is the Hofmann degradation reaction, in which a PAM is treated with hypohalogenites in alkaline solution, which leads to polyvinylamine, a cationic polyelectrolyte. Details of chemical transformations of PAMs under downhole conditions can be found in pending PCT Patent Application WO2011136679, entitled “Subterranean Reservoir Treatment Method.” incorporated by reference herein in its entirety.

Yet another method of controlling (delaying) PEC formation is the utilization of any type of emulsion (oil-in-water, water-in-oil, water-in-water) to transport at least one polyelectrolyte downhole. In a non-limiting example, a fracturing slurry, in addition to proppant and other additives, contains emulsion droplets, stable at ambient conditions, which confine a polyelectrolyte, which therefore is non-reactive towards its oppositely charged counterpart, also present in the slurry. The emulsion breaks either under downhole conditions (at elevated temperature) or by means of a delayed emulsion breaker, releasing the polyelectrolyte, which immediately participates in a PEC formation reaction.

Yet another method of utilizing PEC's is to add one of the polymers or polymer precursors in solid form.

Any other methods of controlled (delayed) PEC formation may be used, for example based on temporary protection of the charged groups of at least one of the polyelectrolytes by means of chemical protection groups or surfactants (by using polyelectrolyte-surfactant complexes).

Other non-limiting examples of pH triggering that may be used to initiate PEC formation include:

1. Use of a mixture containing polyethyleneimine (PEI, which is non-ionic at alkaline pH) plus sulphonated polymer (in which the anionic charge persists at high, neutral and low pH); no PEC will be formed until the pH is changed from alkaline conditions to acidic conditions (whereupon the PEI becomes positively charged). Such a pH change could be triggered by controlled hydrolysis of polylactic acid and/or polyglycolic acid (PLA/PGA) particles.

2. Use of a mixture of chitosan (which is insoluble at alkaline pH) plus sulphonated polymer (in which the anionic charge persists at high, neutral and low pH); no PEC will be formed until the pH is changed from alkaline conditions to acidic conditions (wherein chitosan is dissolved as a cationic polymer). Again, such a pH change could be triggered by controlled hydrolysis of polylactic acid and/or polyglycolic acid (PLA/PGA) particles.

3. Use of a mixture of polyDADMAC (in which the cationic charge persists at high, neutral and low pH) plus a carboxylate polymer (which is anionic at high pH, but non-ionic at pH near and below the pKa). No PEC is formed under acidic conditions; the pH is raised to induce PEC formation.

Yet another way to delay PEC formation is to energize treatment fluid with CO₂. Carbon dioxide lowers pH of treatment fluid. Under high temperature and pressure the carbon dioxide gas could turn to liquid or supercritical state with different properties, thus changing the pH of the system and triggering PEC formation. It should be understood that many different gases can be used to trigger PEC formation as their properties may change at bottomhole conditions.

Triggers other than PEC polymer complexes will lead to similar results. In addition to electrostatic interactions, other forces may be used as a driving force for polymer complex formation. As a non-limiting example, complexes based on hydrogen bonding provide a function similar to that of PECs described above. In a wider sense, in the discussion above, instead of PECs any complex may be used which involves at least one polyelectrolyte. Such a polyelectrolyte can be complexed with a variety of compounds, such as non-ionic polymers, surfactants, and inorganic species (for example, metal ions).

More examples of cationic polyelectrolytes solutions which are used less often in oilfield technologies, as they may be more expensive than their anionic counterparts, include different polyacrylamide copolymers with diallyldimethylammonium chloride (DADMAC), acryloyloxyethyltrimethylammonium chloride (AETAC) and other quaternary ammonium monomers, polyvinyl pyrrolidone (PVP), polyethyleneimine (PEI) and natural polymers, such as chitosan, gelatin (and other polypeptides), and poly-L-lysine.

More examples of anionic polyelectrolytes solutions which are widely used in various oilfield technologies, providing a combination of properties, include: carboxymethylated guars and celluloses (such as carboxymethyl guar, (CMG), carboxymethyl hydroxypropyl guar (CMHPG), carboxymethyl cellulose (CMC), polyanionic cellulose (PAC), carboxymethyl hydroxyethyl cellulose (CMHEC), etc.) These derivatized polysaccharides have polar carboxylic groups, making the polymers more water soluble, chemically resistant and crosslinkable with metals. Many natural and semi-synthetic polymers are also polyanions, such as xanthan, carrageenan, lignosulfonate, etc. Purely synthetic polyanions include polymers based on polyacrylic acid (PA) and polyacrylamide (PAM). They are utilized as flocculants, dewatering agents, and friction reducers and have many other applications. The PAMs contain anionic groups due either to intrinsic hydrolysis of acrylamide to acrylic acid, or due to deliberately incorporated sulfonic groups (e.g. acrylamido-2-methyl-1-propane sulfonic acid, (AMPS).

In yet another embodiment of the disclosed subject matter, the proppant or proppant plus low density particles aggregation or accumulation into clusters takes place due to a phase transition (for instance, precipitation) in a polymer solution. A polymer solution with a low critical solution temperature (LCST) undergoes phase separation at bottomhole temperature and the resulting polymer precipitate consolidates proppant or proppant plus low density particles.

Stimulus-responsive polymers are a wide class of modern functionalized materials. They are able to perceive small changes in external signals, such as pH, temperature, electric/magnetic/mechanical field, or light, and produce corresponding changes or transformation of the physical structure and chemical properties of a polymer solution or gel. Thermally sensitive or thermo-responsive polymers exhibit sensitive responses in their structure, properties, and configuration to changes in temperature. Aqueous solutions of such polymers undergo fast, reversible changes around their lower critical solution temperature (LCST). Below the LCST, the free polymer chains are soluble in water and exist in an extended conformation that is fully hydrated. On the contrary, above the LCST, the polymer chains become more hydrophobic, resulting in the assembly of a phase-separated state. This process is so well studied that LCST can be adjusted by choosing the right polymers from negative temperatures (by Celsius) to above hundred degrees.

Polymers bearing amide groups form the largest group of thermo-sensitive polymers with inverse temperature dependent solubility. Among them, poly(N-isopropylacrylamide) (PNIPAM) and poly(N,N′-diethylacrylamide) (PDEAAM) are most well-known. The properties of a polymer solution, such as the phase transition temperature, depend on the chemical composition and the molecular weight of the polymer and on environmental conditions such as fluid pH and ionic composition and concentration.

Thermo-responsive polymer flocculants can be used for aggregation or accumulation of proppant or proppant plus low density particles in a fracture. The mechanism of proppant or proppant plus low density particles agglomeration includes adsorption of polymer onto the surface of particles at temperatures below the LCST. Under these conditions, polymers are soluble in water, so there is hydrogen bonding between the polymer and water molecules; the polymer chains have an extended random coil conformation. When the temperature is increased above the LCST the hydrogen bonding is weakened, resulting in phase separation of the polymer and water, whereupon the polymer chains collapse and precipitate, entrapping proppant particulates.

The formation of LCST precipitates is also a way to induce or trigger the aggregation or accumulation/agglomeration of proppant or proppant plus low density particles. However, if the formation of LCST precipitates leaves a water-like matrix fluid, leak-off will be high, leaving the clots and proppant or proppant plus low density particles in the fracture. On the other hand, a useful system is obtained if the LCST precipitates are formed in a way such that the residual matrix is a high viscosity low leak-off fluid.

Examples of polymers having low critical solution temperatures includes, but is not limited to, ethylene/vinyl alcohol copolymers; ethylene oxide/propylene oxide copolymers; copolymers of N,N-dimethylacrylamide with methyl acrylate, ethyl acrylate, propyl acrylate, butyl acrylate, 2-ethoxyethyl acrylate, and/or 2-methoxyethyl acrylate; hydroxypropyl cellulose; N-isopropylacrylamide/acrylamide copolymers; copolymers of N-isopropylacrylamide with 1-deoxy-1-methacrylamido-D-glucitol; N-isopropylmethacrylamide; methylcellulose (having various concentrations of methyl substitution); methylcellulose/hydroxypropylcellulose copolymers; polyphosphazene polymers, including poly[bis(2,3-dimethoxypropanoxy) phosphazene], poly[bis(2-(2′-methoxyethoxy)ethoxy) phosphazene], poly[bis(2,3-bis(2-methoxyethoxy) propanoxy)phosphazene], poly[bis(2,3-bis(2-(2′-methoxyethoxyl)ethoxy)propanoxy)phosphazene], and poly[bis(2,3-bis(2-(2′-(2″-dimethoxyethoxy) ethoxy)ethoxy)propanoxy) phosphazene]; poly(ethylene glycol); poly(ethylene oxide)-b-poly[bis(methoxyethoxyethoxy)-phosphazene] block copolymers; poly(ethylene oxide)-b-poly(propyleneoxide)-b-poly(ethylene oxide) triblock copolymer; poly(N-isopropylacrylamide); poly(N-isopropylacrylamide)-poly[(N-acetylimino) ethylene] block copolymers; poly(N-isopropylmethacrylamide); poly(propylene glycol); poly(vinyl alcohol); poly(N-vinyl caprolactam); poly(N-vinylisobutyramide); poly(vinyl methyl ether); poly(N-vinyl-N-propylacetamide); N-vinylacetamide/vinyl acetate copolymers; N-vinylcaprolactam/N-vinylamine copolymers; vinyl alcohol/vinyl butyrate copolymers; N-vinylformamide/vinyl acetate copolymers and combinations of these.

The proppant or proppant plus low density particles aggregates formed by the method of the disclosed subject matter can further be reinforced by resin curing, with fibers, or by other suitable means.

For polyelectrolyte complex (PEC)-induced agglomeration, the treatment sequence may be as follows: inject a pad; inject a slurry containing proppant, low density particles and at least one polyelectrolyte already in charged form and at least one non-ionic polymer, which can be converted to a polyelectrolyte with a charge opposite to that of the first polymer by a trigger or a delay agent; allow proppant or proppant plus low density particles aggregation or accumulation; and allow fracture closure. The concentration of the polyelectrolytes and polyelectrolyte precursors is in the range of from about 0.005 to about 5 weight percent. Suitable triggering mechanisms for PEC formation are listed above. The slurry may further contain oilfield additives, known to those skilled in the art, such as viscosifiers, surfactants, clay stabilizers, bactericides, fibers, etc.

Yet another non-limiting example of pumping sequence for PEC-induced agglomeration is as follows: inject a pad, inject in first stream a slurry containing proppant, low density particles and at least one polyelectrolyte already in charged form, inject simultaneously in second stream at least one polyelectrolyte of opposite charge to the polyelectrolyte in the first stream in already charged form; allow proppant or proppant plus low density particles agglomeration before wellhead or after wellhead (can be controlled by adding delay agents) but before perforations; and allow fracture closure. The concentration of the polyelectrolytes and polyelectrolyte precursors is in the range of from about 0.005 to about 5 weight percent. Suitable triggering mechanisms for PEC formation are listed above. The slurry may further contain oilfield additives, known to those skilled in the art, such as viscosifiers, surfactants, clay stabilizers, bactericides, and fibers.

For the guar-induced syneresis embodiment of causing proppant or proppant plus low density particles agglomeration, the sequence would be as follows: pump a pad stage for fracture initiation; pump fluid comprising proppant and low density particles and a carrier fluid that may undergo syneresis conditions; allow agglomeration of proppant or proppant plus low density particles; and allow the fracture to close on the aggregates formed. In a one embodiment, the fluid formulation additionally contains fibers for agglomerate stabilization and settling prevention.

Another sequence for the guar-induced syneresis agglomeration of proppant or proppant plus low density particles would be as follows: pump a pad stage for fracture initiation; pump fluid comprising proppant and low density particles and a carrier fluid in one line; pump agglomeration trigger and a carrier fluid in a second line; allow agglomeration of proppant or proppant plus low density particles; and allow the fracture to close on the aggregates formed. In one embodiment, the fluid formulation additionally contains fibers for agglomerate stabilization and settling prevention.

For using the LCST approach to agglomeration a suitable sequence of steps is the following: pump a pad stage for fracture initiation; pump proppant and low density particle containing fluid that undergo phase transition at downhole conditions (for example upon heating to downhole temperatures); allow agglomeration of proppant or proppant plus low density particles; and allow the fracture to close on the aggregates formed.

In one embodiment, agglomeration is induced by pumping a pad stage for fracture initiation followed by pumping the two fluids to the perforation region by different flow paths, for example, by pumping one fluid down coiled tubing and pumping the other fluid down the annulus between the coiled tubing and the wellbore. Mixing of the two fluids, in the perforations or after the perforations, induces agglomeration of proppant or proppant plus low density particles. Agglomerated proppant or proppant plus low density particles are transported to the fracture. After the treatment the fracture closes on the agglomerates.

In one embodiment, agglomeration is induced prior to or during injection into the wellbore.

In one embodiment, the agglomerates are formed by 2 seconds of providing the conditions for agglomerate formation. All individual values and subranges from 2 seconds are greater are included herein and disclosed herein. For example, agglomeration may be accomplished within 2-4 seconds, or within 3-5 seconds.

The method of the disclosed subject matter can be used in fractures of any size and orientation. It is particularly suitable for fractures in horizontal wellbores and/or in soft formations. The agglomeration and resulting heterogeneous proppant or proppant plus low density particles placement should occur during the pumping or during an optional shut in period; it should occur before flowback.

### EXAMPLES

### Example 1

The use of polyelectrolyte complexes for agglomeration of proppant particles was demonstrated. The agglomeration of 100 mesh sand was studied in a polyelectrolyte complex (PEC) formed from different oppositely charged chemicals, some examples shown in Table 1. Anionic co-polymers of polyacrylamide (aPAM) were used as “negative charge” species, when the role of “positive charge” species were played by cationic co-polymers of diallyldimethil ammonium chloride and polyacrylamide (cPAM) or surfactants based on quaternary ammonium salts (surf1, surf2). The following solutions were prepared, 5 mL/L of 50% water solution of negatively charged chemical, 6 g of 100 mesh sand and 5 mL/L of 50% water solution of positively charged chemical were mixed in 50 mL of tap water in glass bottles. Resulted solutions were shaken for 3-5 seconds and the sand aggregation or accumulation was observed. In some cases gentle heating of the solution was needed to start the agglomeration (specified in the Table 1), but in the examples shown in Table 1 the total amount of sand was trapped inside the sticky PEC network. Formed clots were stable for several days, no sand disaggregation was observed.

TABLE 1

| Example | Negative charge | Positive charge | |
|---|---|---|---|
| # | (5 mL/L) | (5 mL/L) | PEC formation |
| 1a | aPAM | Surfactant | Yes |
| 1b | aPAM | cPAM | Yes |
| 1c | aPAM | surf2 | Yes, after heating |
| 1d | polyacrylamide in | surf1 | Yes |
| | salt solution | | |
| 1e | PAA | cPAM | Yes |

Table 1 illustrates proppant particles agglomeration in PECs formed from different chemicals.

### Example 2

Agglomeration of sand was studied in PEC formed from anionic polyacrylamide compounds (listed in Example 1 discussion) and protonated polyethyleneimine Polyethyleneimine (PEI) uncharged highly-branched polymer with pH 11-12 in 50% water solution was used. Acids cause protonation of PEI polymer and make it positively charged. The solution was prepared in the following way, 5 mL/L of water solution of anionic co-polymer of polyacrylamide (aPAM), 6 g of 100 mesh sand, 5 mL/L of 50% water solution of PEI with pH 8 (was neutralized by 0.5 mL of 15 wt % HCl) were mixed in 50 mL of tap water in glass bottle and shaken for 3-5 seconds. As the result PEC formation with sand trapped inside was observed.

### Example 3

Formation of buoyant PECs was demonstrated. Glass Bubbles HGS (commercially available from 3M Corporation) with density of 0.4-0.6 g/cm³ were used as a lightweight additive in order to reduce the total density of PEC clots with trapped sand particles. The components were mixed in the following order, 50 mL of water, 5 mL/L of 50% water solution of aPAM, 6 g of 100 mesh sand, 3 g of glass hollow spheres and 5 mL/L of surf1 or PEI polymer with pH 8. After the components were mixed, the resulted solution was shaken for 3-5 seconds and formation of buoyant agglomerates was observed. The total amount of glass bubbles and sand particles was trapped inside formed aggregates. The solution was kept under room temperature for 5 days, and neither disaggregation of PEC complex due to phase separation of low and high density particles nor sand settling was observed.

### Example 4

Superabsorbent was used as a lightweight additive in order to reduce the total density of PEC clots. Superabsorbent is a synthetic organic material that can absorb up to at least 1000 times of its initial weight or at least 100 times of its initial weight or at least 10 times of its initial weight. The components were mixed in the following order, 50 mL of water with 2 wt. % KCl content, 3 mL/L of 30-60% water solution of aPAM, 6 g of 100 mesh sand, 3.6 g/L of superabsorbent powder/particles, 3 mL/L of 50% water solution of PEI with pH 8. After the components were mixed, the resulted solution was shaken for 3-5 seconds and formation of PEC agglomerates was observed. The total amount of superabsorbent powder/particles and sand particles was trapped inside formed aggregates. Due to swelling effect of superabsorbent powder/particles inside of polyelectrolyte network the total density of resulted PECs was reduced from 1.7 to 1.1 g/cm3.

### Example 5

Guar powder was used as a lightweight additive in order to reduce the total density of PEC clots. The components were mixed in the following order, 50 mL of water with 2% KCl content, 1 mL/L of borate crosslinking agent 3 mL/L of 30-60% water solution of aPAM, 6 g of 100 mesh sand, 3.6 g/L of guar powder, then 3 mL/L of ˜50% water solution of PEI with pH 8. After the components were mixed, the resulted solution was shaken for 3-5 seconds and formation of PEC agglomerates was observed. The total amount of guar powder and sand particles was trapped inside formed aggregates. Due to hydration and crosslinking of guar powder inside of polyelectrolyte network the total density of resulted PECs was reduced from 1.7 to 1.3 g/cm3.

### Example 6

Hydrated guar was used as lightweight additive in order to reduce the overall density of PEC clots. Linear gel containing 1.8 g/L of dry guar was prepared in 50 mL bottle and 3 g of 100-mesh were put inside. Solution was slightly shaken and 3 mL/L of anionic co-polymer of polyacrylamide were added. Solution was shaken again and after that PEI was added at concentration of 3 mL/L The resulted slurry was vigorously shaken and in 2-3 minutes agglomerate was formed on the bottom of the bottle. The density of the formed aggregate was measured and it was found to be 1.08 g/cm3.

### Example 7

Two suspensions were prepared. In the first bottle 25 mL of tap water, 1 mL of 85% acetic acid, 0.150 mL of 50% water solution of PEI with pH 8 were mixed. In the second bottle 25 mL of tap water, 0.150 mL of 50% water solution of anionic polyacrylamide, 1 g of sodium carbonate, 6 g of 100 mesh sand, and 25 mg of a proprietary surfactant were mixed. Both bottles were simultaneously poured into a beaker. The foam immediately started to emerge followed by its agglomeration with sand (upon gentle shaking) by means of PEC formation. The formed agglomerates had density less than water and were floating on top.

A similar result was observed with calcium carbonate instead of sodium carbonate. The difference here is that the formation of foam is not instantaneous but rather slow; and the agglomerate slowly comes to the surface with no observable gas release as if the reaction took place inside it.

The same process was repeated without surfactant. In this case the foam does not form. Gas bubbles quickly escape from the suspension. They disturb the suspension, so the PEC forms without shaking.

### Example 8

The use of fibers additive to the carrier liquid in order to reduce the settling rate of PECs with trapped sand particles was studied. The PECs were formed from anionic polyacrylamide (aPAM) and cationic surfactant based on quaternary ammonium salt (surf1) as described in Example 1. Settling tests were performed in graduated 250 mL cylinders filled with slickwater (5 mL/L of aPAM), with 2.4 g/L PLA fibers dispersed in the slickwater. Table 2 illustrates the effect of fibers dispersed in the carrier fluid on settling rate of PECs. As can be clearly seen addition of fibers in the carrier liquid decreases the settling rate of PEC 10 times.

TABLE 2

| | | Settling rate, |
|---|---|---|
| Carrier liquid | Additive | cm/sec |
| Slickwater (5 mL/L) | — | 10 |
| Slickwater (5 mL/L) | 2.4 g/L fibers | 1 |

### Example 9

Effect of salt on agglomeration efficiency of PECs was estimated. Several solutions, containing 5 mL/L of 50% solution of anionic polyacrylamide (aPAM), 6 g of 100-mesh sand and 5 mL/L of 50% solution of cationic surfactant (surf1) or PEI were prepared in glass bottles as previously described (Example 1 and Example 2 respectively), and 50 ml of 2 wt % KCl solution was used instead of tap water. Table 3 illustrates the effect of salt additive on agglomeration efficiency of PECs.

TABLE 3

| Example | Negative charge | | Positive charge | PEC |
|---|---|---|---|---|
| # | (5 mL/L) | Additive | (5 mL/L) | formation |
| 9a | aPAM | 2 wt % KCl | surf1 | No |
| 9b | aPAM | 2 wt % KCl | PEI | Yes |
| 9c | aPAM | 4 wt % KCl | PEI | Yes |

It can be seen that there was no PEC formation in the case of surfactant, while PECs which were based on polyethyleneimine easily formed even in more concentrated salt solution (4 wt % KCl). Without being bound to any particular theory, it is presently believed that the influence of the salts can be explained by their influence on the proposed aggregation or accumulation mechanism: increasing ionic strengths can suppress the electrostatic double layer, and hence the interaction of the oppositely charged species. Nevertheless, specific interactions between the ion(s) of KCl and the anionic polyacrylamide might prevent its interaction with positively charged surfactant, which leads to PEC formation, may also be possible. Without being bound to any particular theory, it is currently thought that formation of PECs from polyacrylamide and PEI polymer is based on a crosslinking mechanism along with electrostatic attraction and the high specific charge of protonated PEI, which might explain their higher tolerance to salt presence.

### Example 10

Effect of pH on agglomeration efficiency of PECs was studied. The used solutions, containing 3 mL/L of 50% water solution of anionic polyacrylamide aPAM, 6 g of 100-mesh sand and 3 mL/L of 50% solution of cationic surfactant (surf1) were prepared in the same manner as described in the Example 1. The pH of the solutions was checked either before the components were mixed or adjusted after agglomerate was formed (by means of HCl or NaOH additive). It was observed that agglomeration efficiency of PEC was quite weak at acidic pH (<4); however, it became better close to the neutral pH. Starting from pH=6, strong agglomeration was observed and the formed agglomerates were stable even in strongly alkaline medium (up to from pH=10 to 13). Analogous procedure was performed using PEI as a positive counterpart. Solutions containing 5 mL/L of 50% water solution of anionic polyacrylamide (aPAM), 6 g of 100-mesh sand, and 1 mL/L of 50% water solution of PEI were prepared and appropriate amount of 15 wt % HCl solution was added to achieve the desired pH. As in the previous case, agglomeration efficiency of PEC was weak at pH<6. As was expected at pH>9 formation of PEC did not occur due to weak protonation of PEI. The pH range from 7-8.5 was found to be optimal for PEC formation and agglomeration of sand in it. It will be understood, however, that dependent upon application, any pH may be used for agglomeration. In one embodiment of the disclosed subject matter, agglomeration occurs at pH from 3 to 13, for example, the pH may range from a lower limit of 3, 4, 5, 6, 7, 8, 9, or 11 to an upper limit of 4, 5, 6, 7, 8, 9, 10, 12, or 13. For example, agglomeration may occur at a pH from 3 to 11, or in another embodiment, from 4 to 10, or in another embodiment, from 5 to 9, or in another embodiment, from 6 to 8, or in another embodiment, from 6 to 10.

### Example 11

The effect of temperature on agglomeration efficiency of PECs was studied. Solutions containing 3 mL/L of 50% water solution of anionic co-polymer of polyacrylamide (aPAM), 6 g of 100-mesh sand, and 3 mL/L of 50% water solution of cationic surfactant based on quaternary ammonium salt (surf1) were prepared in the same manner as described in the Example 1. After agglomerates were formed, the glass bottles were placed in the oven and kept there during fixed time. The experiments showed that the agglomerates were stable during 4 hours at 80° C., but disaggregated after 4 hours at 100° C. PECs formed from anionic polyacrylamide (aPAM) and PEI (prepared as described in the Example 2) showed better temperature stability: even at 140° C. agglomerates stayed stable for 2 hours and lost 30% of sand in 4 hours at the same conditions.

### Example 12

500 mL of linear guar gel with concentration of 2.4 g/L were prepared in 2% KCl aqueous solution. 60 g of proppant (100 mesh sand) and 6 mL of PEI solution (prepared as described in the Example 2) were added to the gel. The mixture was stirred for several minutes and then cross-linked with boron. 250 mL of the cross-inked gel was taken and mixed with 250 mL of aPAM solution (6 mL/L). The resulting mixture was tightened in 1 L bottle and kept at 95° C. for several hours. PEC formation was observed after gentle shaking upon breakage of the gel.

Although the preceding description has been described herein with reference to particular means, materials and embodiments, it is not intended to be limited to the particulars disclosed herein; rather, it extends to all functionally equivalent structures, methods and uses, such as are within the scope of the appended claims. Furthermore, although only a few example embodiments have been described in detail above, those skilled in the art will readily appreciate that many modifications are possible in the example embodiments without materially departing from the disclosure of CONTROLLED INHOMOGENEOUS PROPPANT AGGREGATE FORMATION. Accordingly, such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method to improve fluid flow in a hydraulic fracture from a subterranean formation, the method comprising:
formulating a slurry which comprises (a) proppant particles, (b) a carrier fluid, and (c) low density particles, wherein the carrier fluid is capable of undergoing a transformation to cause an agglomeration of two or more proppant particles and/or low density particles;
injecting the slurry into the formation;
triggering the agglomeration of the proppant particles and/or low density particles,

2. The method of claim 1, wherein the carrier fluid is viscosified by a first polymer gel that can undergo syneresis, and wherein the triggering occurs by triggering gel syneresis.

3. The method of claim 1, wherein the triggering occurs by at least one process selected from the group consisting of phase separation and precipitation and complexation.

4. The method of claim 1, wherein the triggering forms aggregates of two or more proppant particles and low density particles and wherein the low density particles are used to control the density of the aggregates and/or tackiness of the agglomerates, and/or their ability to squeeze through narrow fractures.

5. The method of claim 1, wherein the low density particles are one or more selected from the group consisting of hollow spheres, ash, wood, plastic, superabsorbents, guar based materials, foamed materials or minerals, like pumice, vermiculite, perlite, or others, hydrocarbon dispersions, organic oil dispersions like soy, palm, canola, sunflower oil dispersions or others, animal fat dispersions, and gas dispersions.

6. The method of claim 2 wherein the first polymer gel is a borate crosslinked polymer gel and the syneresis is triggered by incorporation of a multivalent cation or more than one multivalent cations in the gel, and wherein the multivalent cation is a cation of a metal selected from the group consisting of Ca, Zn, Al, Fe, Cu, Co, Cr, Ni, Ti, Zr and mixtures thereof.

7. The method of claim 2 wherein the syneresis is caused by adding a second polymer and a delayed crosslinker for the second polymer to the slurry.

8. The method of claim 2 wherein the gel is a borate crosslinked polymer gel and the syneresis is triggered by change of pH causing collapse of the crosslinked polymer gel.

9. The method according to claim 1, wherein the carrier fluid comprises (i) at least one anionic polyelectrolyte or a precursor to at least one anionic polyelectrolyte, and (ii) at least one cationic polyelectrolyte or a precursor to at least one cationic polyelectrolyte and the agglomeration occurs by triggering formation of a polyelectrolyte complex.

10. The method of claim 9 wherein the formation of the polyelectrolyte complex is induced by one or more processes selected from the group consisting of a pH change, conversion of at least one polyelectrolyte precursor to a polyelectrolyte, formation of a cationic polyelectrolyte downhole, and formation of an anionic polyelectrolyte downhole.

11. The method according to claim 1, wherein the carrier fluid is capable of undergoing a transformation to cause the agglomeration of two or more proppant particles and/or low density particles, and the slurry further comprises a first component of a polyelectrolyte complex, and a second component of the polyelectrolyte complex held within containers made from degradable/soluble material at required well downhole conditions and/or any type of containers which are subjected to pressure/shear degradation.

12. The method of claim 11 wherein the containers are microcapsules.
